(19) United States
(12) Patent Application Publication
(10) Pub. No.: US 2008/0170256 A1
(43) Pub. Date: Jul. 17, 2008

(54) Image processing apparatus for sending message to user according to presence/absence of sheet in exit tray, and controlling method thereof

(75) Inventors: Kenji Matsuhara, Kawanishi-shi (JP); Hiroaki Kubo, Muko-shi (JP); Nobuhiro Mishima, Osaka-shi (JP); Kazuo Inui, Itami-shi (JP)

Correspondence Address: MORRISON & FOERSTER LLP, 1650 TYSONS BOULEVARD, SUITE 400, MCLEAN, VA, 22102, US

(73) Assignee: Konica Minolta Business Technologies, Inc., Tokyo (JP)

(21) Appl. No.: 11/797,221

(22) Filed: May 1, 2007

(30) Foreign Application Priority Data
Jan. 16, 2007 (JP) 2007-007079

(51) Int. Cl. G06K 15/02

(52) U.S. Cl. 358/1.15

(57) ABSTRACT

In an image processing apparatus, information identifying a user and information identifying portable terminal unit are stored in correlation with each other. After a sheet based on a certain printing request is outputted to an exit tray of the image processing apparatus, whether or not a sheet is present in the exit tray is judged, and whether or not a user having transmitted the printing request is situated within a predetermined distance from the image processing apparatus is judged. A message selected based on these judgment results is sent to a mobile terminal unit correlated with information identifying the user.

This application is based on Japanese Patent Application No. 2007-007079 filed with the Japan Patent Office on Jan. 16, 2007, the entire content of which is hereby incorporated by reference.

### BACKGROUND OF THE INVENTION

1. Field of the Invention

The present invention relates to an image processing apparatus and a controlling method thereof, and in particular, to an image processing apparatus for outputting a sheet to an exit tray by executing printing based on a printing request received via a network, and a controlling method thereof.

2. Description of the Related Art

In recent MFPs (Multi Function Peripherals), there are increased opportunities of receiving printing requests remotely from various devices connected with the MFP via a network, such as a printing request instructed from other MFP (so called “push print”) or a printing request from a mobile terminal, as well as receiving a printing request transmitted from a personal computer (hereinafter, abbreviated as PC).

As the opportunity of connecting various devices with MFP via a network increases, the MFP receives printing requests from the various devices via a network more frequently, and hence executes printing output in correspondence with more printing requests from more users.

For enhancing security management when such printing requests are issued toward MFP, a technique of identifying an operating user by user authentication through a driver screen or an operating screen of other device has been generally employed (see, for example, Japanese Laid-Open Patent Publication No. 2006-106940). Also with the spread of mobile terminals such as mobile phones, a technique of notifying a mobile terminal carried by a user of various information from MFP has been disclosed (see, for example, Japanese Laid-Open Patent Publication Nos. 2004-120199, 2005-168015, and 2005-082339).

In MFP, when printing outputs are executed in response to printing requests from a large number of devices, there arises the problem that a plenty of printed matters accumulate on the exit tray of the MFP or a different user takes away the printed matters because the users do not pick up the output printed matters. For solving such problems, in conventionally proposed techniques, as disclosed in Japanese Laid-Open Patent Publication No. 2004-299242, a sensor for detecting presence/absence of sheet is provided for an exit tray, and when the sensor detects presence of a sheet for a predetermined time or more, an alert message is displayed on PC of the user that made the sheet output, or information identifying the user is forcedly printed.

However, in the technique disclosed in Japanese Laid-Open Patent Publication No. 2004-299242, since an alert to a user is made on the PC used by the user, the user often fail to recognize that the user is alerted, when the user is away from the PC, and since the alert is made according to the presence/absence of sheet on the exit tray, there arises the situation that the alert is made based on the presence of the sheet that is outputted and neglected by other user. Further, even if information that identifies the user who requests the print output and neglects the sheet is printed, the alert will not work unless the relevant user looks the sheet printed by the MFP.

### SUMMARY OF THE INVENTION

The invention was devised in consideration of the above circumstances, and it is an object of the present invention to provide an image processing apparatus capable of reliably notifying a user of information corresponding to situation when the user having transmitted a printing request neglects a sheet outputted according to the printing request in the image processing apparatus, and a method of controlling the same.

An image processing apparatus according to the present invention is an image processing apparatus includes an exit tray collects a printed sheet; a user information storing unit that stores information identifying a user and information identifying a mobile terminal while correlating with each other; a judging unit that judges whether or not a sheet is present on the exit tray; a deciding unit that decides whether or not a user having transmitted a first printing request is situated within a predetermined distance from the image processing apparatus after a sheet based on the first printing request is outputted; a selecting unit that selects a message based on results of judgment by the judging unit and decision by the deciding unit; and a sending unit that sends the message selected by the selecting unit to a mobile terminal unit that is correlated in the user information storing unit with information identifying the user having transmitted the first printing request.

A method of controlling an image processing apparatus of the present invention is a method of controlling an image processing apparatus for outputting a sheet to an exit tray by executing printing based on a printing request received via a network, and includes the steps of: storing information identifying a user and information identifying a mobile terminal while correlating with each other; judging whether or not a sheet is present in the exit tray; deciding whether or not a user having transmitted a first printing request is situated within a predetermined distance from the image processing apparatus after a sheet based on the first printing request is outputted; selecting a message based on results of the judging step and the deciding step; and sending the message selected by the selecting step to a mobile terminal unit that is correlated with information identifying the user having transmitted the first printing request.

According to the present invention, a user having transmitted a printing request is notified of a message corresponding to the information on whether the user has approached the image processing apparatus after requesting the printing, and information on whether a sheet corresponding to the printing request remains in the exit tray. As a result, the user can be notified of information corresponding to the situation. According to the present invention, a user having transmitted a printing request is notified of a message as described above through a mobile terminal correlated with the user. Accordingly, the user is notified of the information reliably.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a view schematically showing configuration of an image processing system including one embodiment of an image processing apparatus of the present invention.

FIG. 2 is a view showing appearance of a MFP which is one embodiment of an image processing apparatus of the present invention.

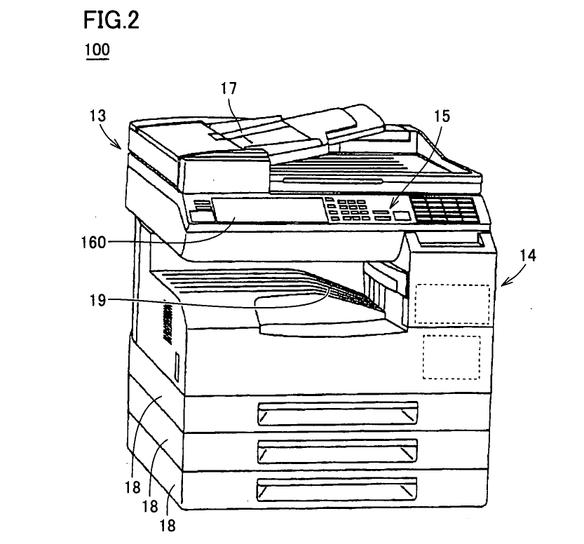

FIG. 3 is a block diagram of hardware of MFP in FIG. 2.

FIG. 4 is a flowchart of a process performed in execution of printing job received via a network in MFP in FIG. 2.

FIG. 5 is a flowchart of a process performed in execution of printing job received via a network in MFP in FIG. 2.

FIG. 6 is a flowchart of a process performed in execution of printing job received via a network in MFP in FIG. 2.

FIG. 7 is a flowchart of a process performed in execution of printing job received via a network in MFP in FIG. 2.

FIG. 8 is a flowchart of sub routine of count processing of set pickup time in processes of FIGS. 4 to 7.

FIG. 9 is a flowchart of a process performed in execution of copying job received via a network in MFP in FIG. 2.

FIG. 10 is a flowchart of a process performed in execution of copying job received via a network in MFP in FIG. 2.

FIG. 11 is a flowchart of a process performed in execution of copying job received via a network in MFP in FIG. 2.

FIG. 12 is a flowchart of a process performed in execution of copying job received via a network in MFP in FIG. 2.

FIG. 13 is a view showing one example of screen displayed in a display unit of MFP in FIG. 2.

FIG. 14 is a flow chart of a process performed in execution of scanning job received via a network in MFP in FIG. 2.

FIG. 15 is a flow chart of a process performed in execution of scanning job received via a network in MFP in FIG. 2.

FIG. 16 is a flow chart of a process performed in execution of scanning job received via a network in MFP in FIG. 2.

FIG. 17 is a flow chart of a process performed in execution of scanning job received via a network in MFP in FIG. 2.

FIG. 18 is a view showing other example of screen displayed in a display unit of MFP in FIG. 2.

### DESCRIPTION OF THE PREFERRED EMBODIMENTS

In the following, preferred embodiments of the present invention will be explained with reference to drawings. In this explanation, the same constituent is denoted by the same reference numeral throughout every drawing.

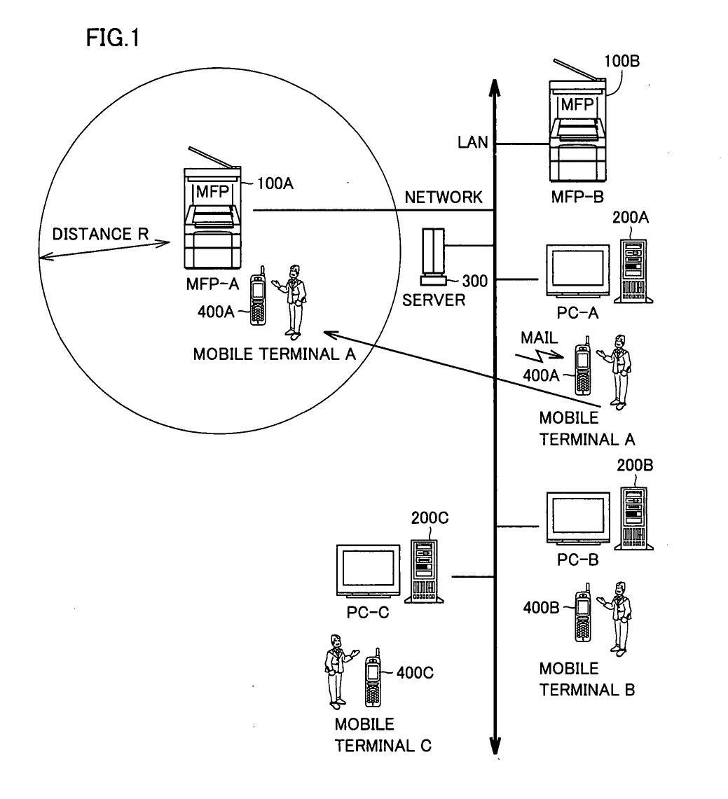

With reference to FIG. 1, an image processing system includes a MFP 100A, a MFP 100B (“MFP 100” for generic designation of MFP), a PC 200A, a PC 200B, a PC 200C (“PC 200” for generic designation of PC), a server 300, a mobile terminal 400A, a mobile terminal 400B, and a mobile terminal 400C (“mobile terminal 400” for generic designation of mobile terminal). These are mutually connected via a network.

In the present embodiment, in MFP 100, a message to be sent to mobile terminal 400 carried by an intended user is selected according to whether or not a sheet outputted to an exit tray by execution of printing job remains, and whether or not the user having transmitted the job to MFP 100 has approached within distance R from MFP 100 after execution of the printing job in MFP 100.

MFP 100 has a key operational unit 15 for receiving operational instruction for various processing and input of character and numerical data. Key operational unit 15 is provided with a plurality of keys such as power key for accepting user operation.

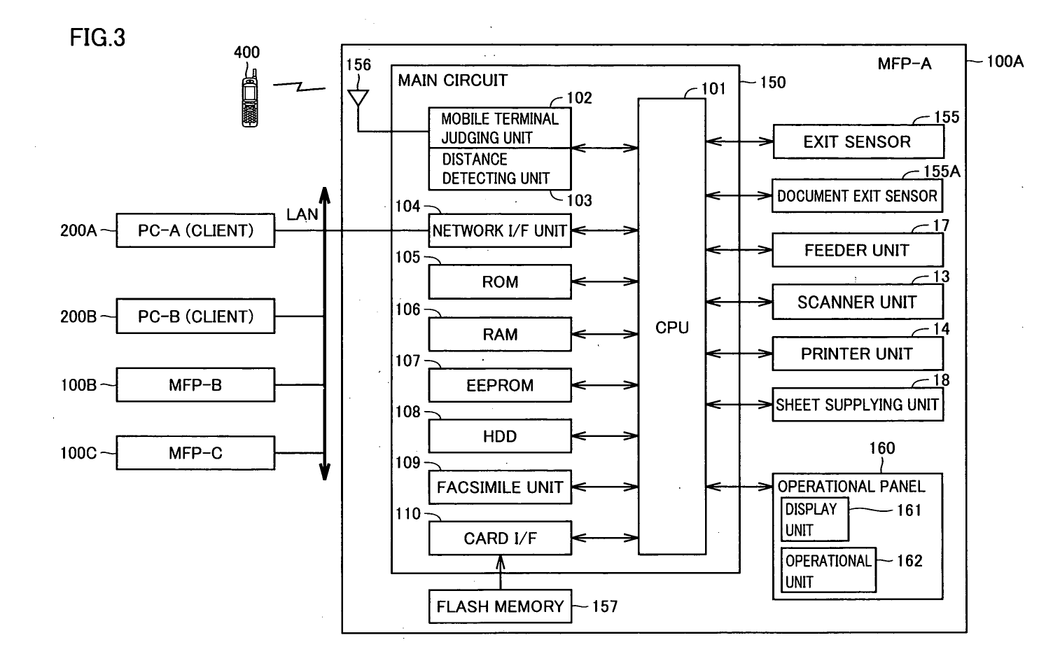

MFP 100 has an operational panel 160 for displaying operation menu or information concerning acquired image. Operational panel 160 is a touch-panel type display which is configured to display operational menu and the like, and to receive operations made on MFP 100 by detecting a contact operation made on image of displayed operational button. In operational panel 160, a portion where information is displayed is referred to as a display unit 161 (see FIG. 3) and a portion where operational buttons are displayed is referred to as an operational unit 162 (see FIG. 3).

MFP 100 also has a scanner unit 13 which photoelectrically reads a document to acquire image data, and a printer unit 14 which prints an image on a sheet based on image data.

MFP 100 also has a feeder unit 17, on top face of its body, which feeds a document to scanner unit 13, a sheet supplying unit 18, in its lower portion, for supplying printer unit 14 with a sheet, and an exit tray 19, in its middle portion, to which a sheet on which an image is printed by printer unit 14 is discharged.

Scanner unit 13 acquires photoelectrically reads image information such as photograph, character, picture and the like from a document to acquire image data. The acquired image data (density data) is stored in RAM (Random Access Memory) 106 as will be described later after processed appropriately, and used as data for attached file to be attached to electric mail, or transmitted to printer unit 14 and/or a communication unit (not shown) mounted inside the apparatus to be provided for image printing or data transmission.

Printer unit 14 prints an image on a sheet based on image data acquired by scanner unit 13, image data received from an external device by the communication unit and the like.

The communication unit sends/receives facsimile data over public telephone lines, and carries out data sending/reception via various networks with an external device connected via such networks, using an electric mail system or the like. As a result, MFP 100 functions not only as a facsimile device that carries out usual facsimile communication, but also as a sending/receiving terminal of electric mail. Therefore, various image data may be sent or received as an attached file of electric mail. Network communication carried out by MFP 100 may be wired-communication of radio communication.

In the present embodiment, since any of MFP 100A, MFP 100B, and MFP 100C may have similar hardware configuration, the following explanation will be made about hardware configuration of MFP 100 with reference to FIG. 3.

With reference to FIG. 3, MFP 100 has besides the aforementioned constituents, a main circuit 150 including a CPU (Central Processing Unit) 101 generally controlling operation of MFP 100, an antenna 156, a flush memory 157, an exit sensor 155 for detecting whether or not a sheet is present in exit tray 19, and a document exit sensor 155A for detecting whether or not a document is present at a document exit port of feeder unit 17. When exit tray 19 includes a plurality of bins, exit sensor 155 is able to detect presence/absence of sheet for each bin.

Main circuit 150 includes, besides CPU 101, a mobile terminal judging unit 102 for judging a user to which mobile terminal 400 being in communication belongs, a distance detecting unit 103 for detecting distance between user and MFP 100, a network I/F (interface) unit 104 which is a part of the communication unit for carrying out sending/reception of information with other information device via a network, a ROM (Read Only Memory) 105, a RAM 106, an EEPROM (Electronically Erasable and Programmable Read Only Memory) 107, a hard disk drive (HDD) 108, a facsimile unit 109, and a card I/F 110. Facsimile unit 109 executes a processing for sending facsimile.

Distance detecting unit 103 detects, for example, distance from an IC (Integrated Circuit) tag possessed by each user, and detects information identifying the user, registered in the IC tag, to thereby detect which user is situated at which distance from MFP 100.

HDD 108 stores a user information management table which correlates name of user, name of operated PC, name of possessed mobile terminal, mail address for use in sending electric mail to the mobile terminal, phone number of the mobile terminal, and operation limitation setting information as will be described later. One exemplary content of user information management table is shown in Table 1.

TABLE 1
User information management table

| | | | | Mobile | Operation |
|---|---|---|---|---|---|
| | Mobile | | | terminal phone | limitation |
| PC name | terminal name | User name | Mail address | number | setting |
| PC-A | Mobile | User A | aaa@konicaminolta.Jp | 072-777-0000 | II |
| | terminal A | | | | |
| PC-B | Mobile | User B | bbb@konicaminolta.Jp | 072-777-0001 | III |
| | terminal B | | | | |
| PC-C | Mobile | User C | ccc@konicaminolta.Jp | 072-777-0002 | I |
| | terminal C | | | | |
| . | . | . | . | . | . |
| . | . | . | . | . | . |
| . | . | . | . | . | . |

Table 1 shows information on three users, user A, user B and user C (client name (name assigned to operated PC), mobile terminal name (name assigned to mobile terminal such as phone number of possessed mobile phone), user name, mail address (mail address corresponding to mobile terminal name), mobile terminal phone number (phone number corresponding to mobile terminal name), and operation limitation setting information).

In the present embodiment, operation limitation setting information is information specifying limitation content about remote transmission of printing job to MFP 100, which is defined by three levels, I, II and III. When a user set to I remotely transmits printing job to MFP 100, an alert mail is sent to the user and printing operation is executed. When a user set to II remotely transmits printing job to MFP 100, a printing operation based on the printing job is executed in condition that the user approaches within distance R from the MFP 100. When a user set to III remotely transmits printing job to MFP 100, a printing operation based on the printing job is executed in condition that the user operates operational unit 162 of operational panel 160 of MFP 100. Distance R may be determined depending on arrangement of MFP or performance of a detector of detecting distance from user mounted in MFP, and may be a distance that permits a person to pick up a sheet discharged in the tray in MFP, for example, about 1 to 2 meter(s).

In the present embodiment, in the user information management table, not every user is correlated with operation limitation setting information. The user who is not correlated with operation limitation setting information will not be limited in any way for remote transmission of printing job to MFP 100.

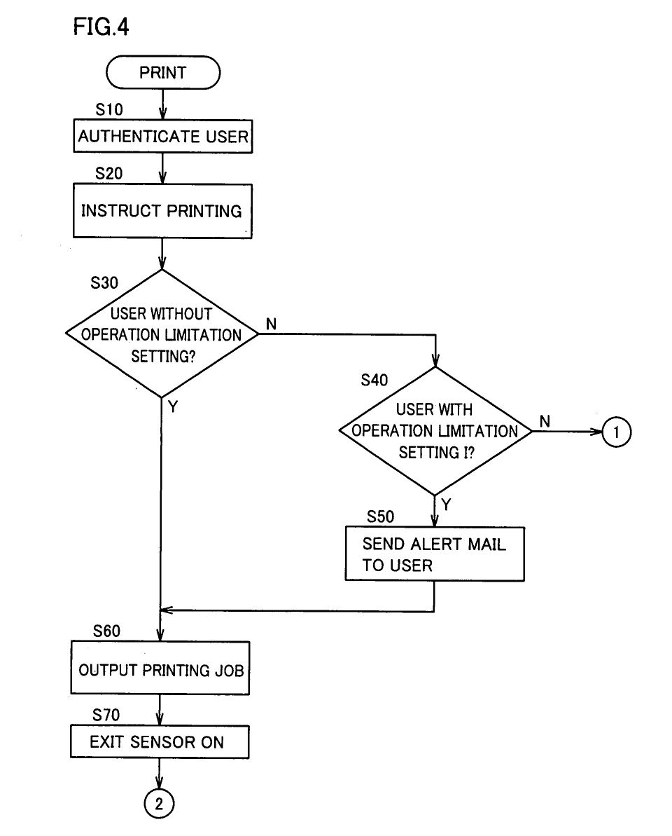

Next, with reference to FIG. 4 to FIG. 7, a process in MFP 100A in execution of printing operation based on a printing request transmitted from other device via a network will be explained.

First, with reference to FIG. 4, upon reception of a printing request transmitted from other device via a network, CPU 101 conducts user authentication on a user who has transmitted the printing request in step S10, and advances the process to step S20. In this user authentication, CPU 101 requests, for example, entry of ID (user name) and password of the user. Server 300 stores, for each user, user ID and password in correlation with information such as mail address concerning the user. CPU 101 advances the process to step S20 when the combination of, for example user ID and password inputted in step S10 coincides with that stored in server 300. When CPU 101 decides that the combination of user ID and password inputted in step S10 is different from that stored in server 300, the process ends at this point. In the following context, deciding that combination of user ID and password coincides with that stored in server 300 made by CPU 101 in step S10 is regarded as authenticating user who has inputted the user ID and password made by CPU 101.

In step S20, CPU 101 instructs printer unit 14 to execute printing operation based on the received printing request, and advances the process to step S30.

In step S30, CPU 101 decides whether or not the user authenticated in step S10 is a user for which operation limitation setting information is not stored by looking up the user information management table. When it is decided as Yes, the process advances to step S60, and when it is decided as No, the process advances to step S40.

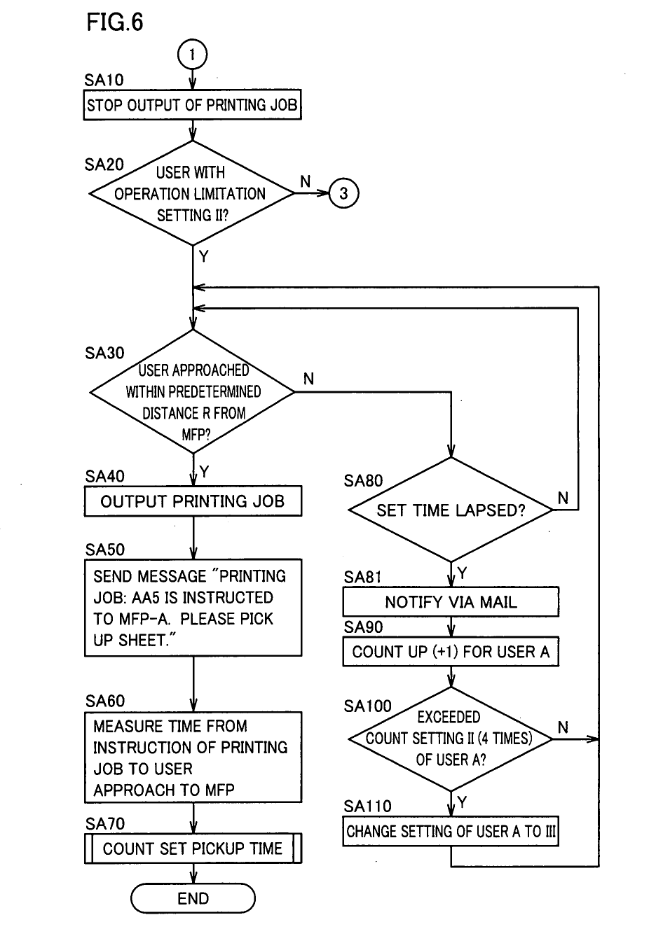

In step S40, CPU 101 decides whether or not the user authenticated in step S10 is a user for which operation limitation setting information is set to I. When it is decided as Yes, the process advances to step S50, and when it is decided as No, the process advances to step SA10 (see FIG. 6).

In step S50, CPU 101 sends an alert mail to the user authenticated in step S10, and advances the process to step S60. CPU 101 acquires mail address of the user by looking up the user information management table.

Such alert mail sent here may be a message “Please pick up printing job immediately”, for example.

In step S60, CPU 101 makes printer unit 14 print out the printing job instructed in step S20, and advances the process to step S70.

In step S70, CPU 101 turns ON output of exit sensor 155, and advances the process to step S80.

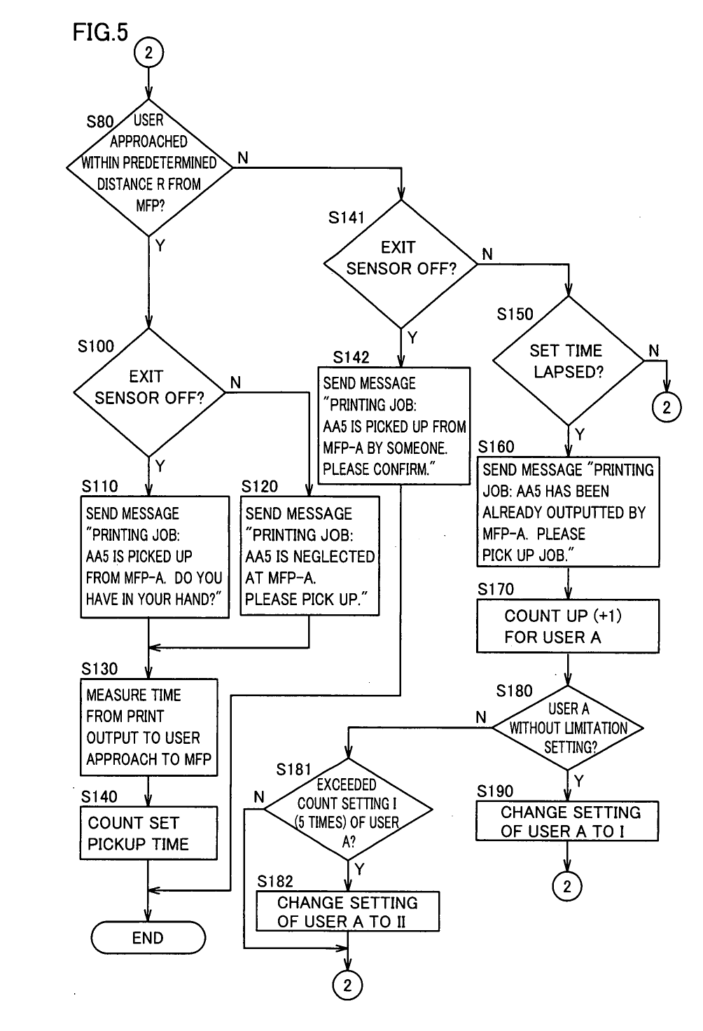

With reference to FIG. 5, in step S80, CPU 101 decides whether or not the user has approached within distance R from MFP 100. When it is decided as Yes, the process advances to step S1100, and when it is decided as No, the process advances to step S141.

In step S100, CPU 101 judges whether or not detection output of exit sensor 155 is OFF, and when the judgment result is OFF, the process advances to step S110, and when the judgment result is not OFF, the process advances to step S120. “Output of exit sensor 155 is OFF” means the condition that no sheet is placed on a corresponding sheet discharge bin. On the other hand, “output of exit sensor 155 is ON” means the condition that a sheet is placed on a corresponding sheet discharge bin.

In step S110, CPU 101 sends a message notifying that a sheet outputted based on the printing job is picked up, to mobile terminal 400 of the user having transmitted the printing job outputted in step S60, and advances the process to step S130. For example, when the printing job outputted in step S60 is referred to as “AA5”, and MFP 100A is treated under the name of “MFP-A” in the image processing system, a message “Printing job: AA5 is picked up from MFP-A. Do you have in your hand)”, for example, is sent in step S110.

In step S120, CPU 101 sends a message notifying that a sheet of printing job outputted in step S60 is neglected, to the user authenticated in step S1. When names of printing job and MFP 100A are as described above in the image processing system, a message “Printing job: AA5 is neglected at MFP-A. Please pick up”, for example, is sent.

In step S130, CPU 101 measures a time from output of printing job in step S60 to approach of the user to MFP 100A (it is decided in step S80 that the user has approached within distance R from MFP 100A), and advances the process to step S140.

In step S140, CPU 101 executes count processing of set pickup time, and ends the process. Details of the count processing of set pickup time will be described later.

On the other hand, in step S141, CPU 101 judges whether or not output of exit sensor 155 is turned OFF, and when the judgment result is OFF, the process advances to step S142, and when the judgment result is not OFF, the process advances to step S150.

In step S142, CPU 101 sends a message notifying that a sheet of printing job transmitted from the user has been picked up by someone, to mobile terminal 400 of the user authenticated in step S10, and ends the process. The message sent in step S142 may be, for example, “Printing job: AA5 is picked up from MFP-A by someone. Please confirm.”, when the name of transmitted printing job is “AA5”, and the name of MFP 100A in image processing system is “MFP-A”.

Instep S150, CPU 101 decides whether or not a time set for each user has lapsed from output of printing job in step S60. Explanation of setting time for each user looked up here, explanation will be made with reference to Table 2.

TABLE 2
Setting time management table

| User | | Accumulative | | |
|---|---|---|---|---|
| name | Notification setting time | number | Operation limitation content | |
| User A | (1) Notify via mail after 30 min. | 7 | I | Alert mail at fifth time |
| | (2) Notify via mail after 1 hr. | 6 | II | Prohibit printing at fourth time, and |
| | | | | permit printing after approach to |
| | | | | MFP |
| | (3) Notify via mail after 3 hr. | 4 | III | Prohibit printing at third time, and |
| | | | | permit printing by operation on |
| | | | | MFP |
| User B | (1) Notify via mail after 40 min. | 1 | I | Alert mail at third time |
| | (2) Notify via mail after 1 hr. | 0 | II | Prohibit printing at second time, |
| | and 10 min. | | | and permit printing after approach |
| | | | | to MFP |
| | (3) Notify via mail after 3 hr. | 0 | III | Prohibit printing at first time, and |
| | | | | permit printing by operation on |
| | | | | MFP |
| User C | (1) Notify via mail after 20 min. | 0 | I | Alert mail at third time |
| | (2) Notify via mail after 40 min. | 0 | II | Prohibit printing at third time, and |
| | | | | permit printing after approach to |
| | | | | MFP |
| | (3) Notify via mail after 3 hr. | 0 | III | Prohibit printing at third time, and |
| | | | | permit printing by operation on |
| | | | | MFP |
| . | . | . | | . |

Table 2 shows one example of setting time management table stored in HDD 108. This setting time management table stores for each user, notification setting times (1) to (3), an accumulative number for each notification setting time, and operation limitation content corresponding to operation limitation setting information on each user.

Notification setting time means a time from execution of printing job transmitted by each user to MFP 100 to notification made to the user via mail. In setting of Table 2, user A is notified via a first mail after a lapse of 30 minutes from execution of the printing job, via a second mail after a lapse of one hour, and via a third mail after a lapse of three hours, for example.

The accumulative number is a number of notifications made via the respective mails of (1) to (3) for each user.

Operation limiting content is content concerning limitation of operation or the like imposed on each user in transmitting printing job to MFP 100A. For example, in Table 2, operation limitation content for user A will be explained. Notification setting time (1) of user A contains a number of times “5 times”. Information on the number contained in the operation limitation content has relation with the aforementioned accumulative number. In the case where the set operation limitation information on user A is I, when the accumulative number about notification setting time (1) of user A reaches 5, a mail informing that limitation will be tightened for the operation of transmitting printing job to MFP 100A in the next and subsequent time unless the sheet outputted by MFP 100A is picked up earlier. In the case where operation limitation setting information on user A is II, when the accumulative number about notification setting time (2) of user A reaches 4, printing operation of printing job transmitted by the user A is not executed unless the user A approaches within distance R from MFP 100 A. In the case where operation limitation setting information on user A is III, when the accumulative number about notification setting time (3) of user A reaches 3, user A is disabled to transmit printing job to MFP 100A via a network, and is disabled to directly cause the operational unit of MFP 100A to output job.

Referring again to FIG. 5, when it is decided that a set time has lapsed in step S150, CPU 101 sends in step S160 a message for requesting job pickup to the user who is a transmitter of the job outputted in step S60. When names of printing job and MFP 100A are “AA5” and “MFP-A”, respectively, in step S160, a message of “Printing job: AA5 has been already outputted by MFP-A. Please pick up the job” is sent to a mobile terminal of the user. When operation limitation setting information is not set for the user having transmitted the printing job outputted in step S60, CPU 101 decides whether or not a predetermined time (for example, one hour) has lapsed in step S150.

In step S170, CPU 101 counts up the accumulative number in setting time management table by one, and advances the process to step S180. The accumulative number which is counted up here is an accumulative number corresponding to the time which is decided to have lapsed in previous step S150 in notification setting times (1) to (3) for the user having transmitted the printing job outputted in step S60.

In step S180, CPU 101 decides whether or not the user having transmitted the printing job outputted in step S60 is a user for which operation limitation setting information is not set, and when it is decided as Yes, the process advances to step S190, and when it is decided as No, the process advances to step S181.

In step S190, limitation setting of the user is changed to “setting I” and the process is returned to step S80.

On the other hand, in step S181, CPU 101 decides whether or not the accumulative number corresponding to I of user for which the accumulative number is counted up in step S170 exceeds the number defined by operation limitation content, and when it is decided as Yes, the process advances to step S182, and when it is decided as No, the process is returned to step S80.

In step S182, CPU 101 updates operation limitation setting information on the user for which the accumulative number is counted up in step S170 to II, and returns the process to step S80.

In the foregoing process described with reference to FIG. 4 and FIG. 5, when operation limitation setting information on the user having transmitted printing job to MFP 100A is I or not set, the transmitted printing job is executed even when the user does not approach MFP 100A. Accordingly, in MFP 100A of the present embodiment, when exit sensor 155 comes into OFF (not detecting sheet) after a sheet is outputted to exit tray 19 by execution of printing job and before the user having transmitted the printing job approaches MFP 100A within distance of R, a message is sent to the user.

In the process explained with reference to FIG. 4 and FIG. 5, as for a user for which operation limitation setting information is not set, operation limitation setting information is set when an output sheet of printing job transmitted to MFP 100A is not picked up for a predetermined time (for example, one hour) or more.

In the foregoing process explained with reference to FIG. 4 and FIG. 5, when a user for which operation limitation setting information is set to I transmits printing job to MFP 100A, MFP 100A outputs the printing job after sending an alert mail to mobile terminal 400 of the user. When the user does not approach to MFP 100A within distance R, the fact that the job has been already outputted is notified according to the time after output of the job, and when the accumulative number exceeds an upper limit defined by the operation limitation content, the operation limitation setting information is updated to II.

On the other hand, when it is decided in step S40 that operation limitation setting information on the user authenticated in step S10 is not I, CPU 101 advances the process to step SA10 (see FIG. 6). In step SA10, CPU 101 makes output of printing job instructed to printer unit 14 in step S20 stop, and advances the process to step SA20.

In step SA20, CPU 101 decides whether or not the operation limitation setting information on the user authenticated in step S10 is II, and when it is decided as Yes, the process advances to step SA30, and when it is decided as No, the process advances to step SA120.

In step SA30, CPU 101 decides whether the user authenticated in step S10 has reached within a distance of R from MFP 100A, and when it is decided as Yes, the process advances to step SA40, and when it is decided as No, the process advances to step SA80.

In step SA40, the printing job stopped in step SA10 is cause to be outputted again, and the process advances to step SA50.

In step SA50, CPU 101 sends a message that informs a particular MFP at which the printing job transmitted from the user is executed, and that urges pickup of sheet outputted by execution of the job, to a mobile terminal of the user authenticated in step S10. For example, a message “Printing job: AA5 is instructed to MFP-A. Please pick up the sheet.” is sent.

Next, CPU 101 measures in step SA60, the time from making instruction for printing to printer unit 14 in step S20 to the point of time when the user approaches within distance R from MFP 100A in step SA30, and then in step SA70, executes count processing of set pickup time, and ends the process. Details of the count processing of set pickup time executed in step SA70 will be described later.

In step SA80, CPU 101 decides whether or not notification setting time set in setting time management table has lapsed from it instructs printing to printer unit 14 in step S20, and when it is decided that the time has lapsed, the process is advanced to step SA81, and when it is decided that the time has not lapsed, the process is returned to step SA30. Notification setting time which is looked up for decision in step SA80 is set for each user as shown in Table 2. And in step SA80, notification setting time for the user authenticated in step S10 is used in decision.

In step SA81, CPU 101 sends a mail informing that notification setting time has lapsed, to the user authenticated in step S10, and advances the process to step SA90.

In step SA90, the accumulative number corresponding to notification setting time that has decided to have lapsed in step SA80 is counted up by one, and the process advances to step SA100.

In step SA100, CPU 101 decides whether or not the accumulative number corresponding to II exceeds an upper limit defined by operation limitation content corresponding to II, for the user for which the accumulative number is counted up in step SA90, in setting time management table. When it is decided as Yes, the process advances to step SA 110, and when it is decided as No, the process advances to step SA30. For example, taking user A as an example, the accumulative number corresponding to II is “6”, and operation limitation content corresponding to II is “4 times”. Therefore, in the example shown in Table 2, it is decided in step SA100, that the accumulative number exceeds an upper limit defined by operation limitation content.

In step SA110, CPU 101 updates operation limitation setting information on the user which is an object of decision to III, and returns the process to step SA30.

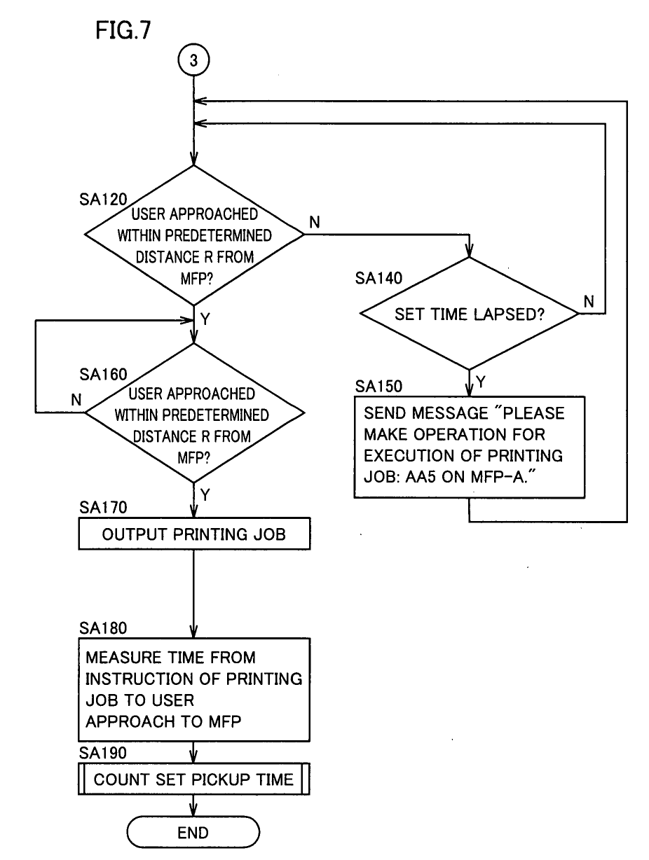

In step SA20, when it is decided that operation limitation setting information on the user authenticated in step S10 is not II, CPU 101 advances the process to step SA120 (see FIG. 7).

In step SA120, CPU 101 decides whether or not the user authenticated in step S10 approaches within distance R from MFP 100A, and when it is decided as Yes, the process advances to step SA 160, and when it is decided as No, the process advances to step SA140.

In step SA160, whether or not a process for executing job transmitted to MFP 100A by the user authenticated in step S 10 is executed on operational panel 160 is decided, and when it is decided as Yes, the process advances to step SA170.

In step SA170, CPU 101 causes the printing job stopped in step SA10 to be outputted, and advances the process to step SA180.

In step SA180, CPU 101 measures the time from instruction of printing operation to printer unit 14 in step S20 to the point of time when the user approaches within distance R from MFP 100A in step SA120, and advances the process to step SA190.

In step SA190, CPU 101 executes a count processing of set pickup time, and ends the process. Details of the count processing of set pickup time executed in step SA190 will be described later.

In step SA140, CPU 101 decides whether or not notification setting time corresponding to the user authenticated in step S10 in setting time management table has lapsed from instruction of printing operation on printer unit 14 in step S20, and when it is decided as Yes, the process advances to step SA150, and when it is decided as No, the process advances to step SA120.

In step SA150, CPU 101 sends a message for urging to make an operation of starting the printing job transmitted from the user on operational panel 160 of MFP 100A (for example, “Please make operation for executing printing job: AA5 in MFP-A.”) to mobile terminal 400 of the user authenticated in step S10, and returns the process to step SA120.

In the foregoing process as explained with reference to FIG. 4 to FIG. 7, when a user whose operation limitation setting information is II transmits printing job to MFP 100A, the printing job is executed in condition that the user approaches within distance R from MFP 100A. When the user does not approach within distance R from MFP 100A after transmitting printing job, the accumulative number in setting time management table is counted up according to lapse time from transmission of the printing job. When the accumulative number exceeds an upper limit number defined by operation limitation setting information on the user, operation limitation setting information on the user is set to III.

In the foregoing process explained with reference to FIG. 4 to FIG. 7, when a user whose operation limitation setting information is III transmits printing job to MFP 100A, the printing job is executed in condition that the user approaches within distance R from MFP 100A and makes an operation for executing the job on operational panel 160. When the user does not approach within distance R from MFP 100A after transmitting printing job, a message that urges to make an operation for executing the printing job in MFP 100A is sent to mobile terminal 400 of the user every time a notification setting time set by the setting time management table has lapsed from transmission of printing job.

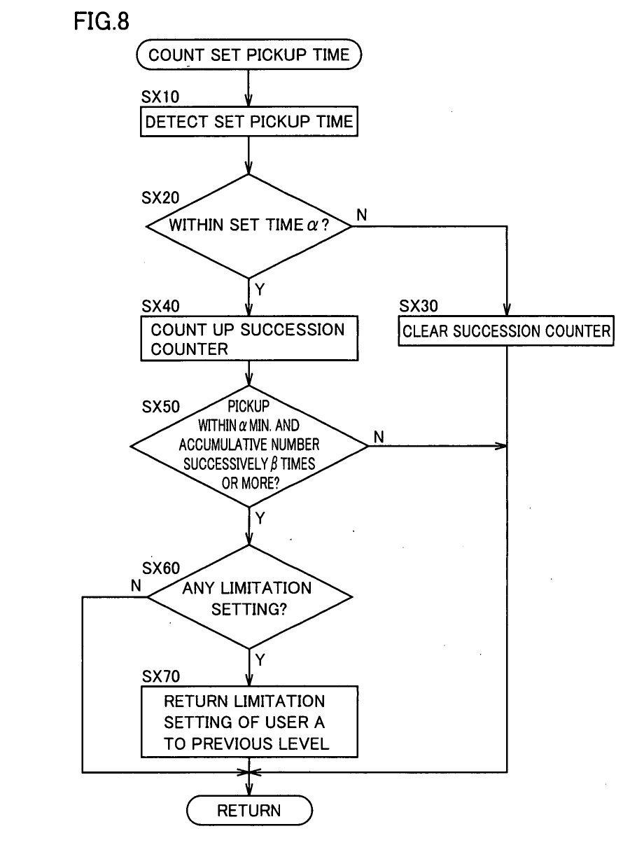

FIG. 8 is a flowchart showing sub routine of count processing of set pickup time executed in step S140, step SA70, and step SA190.

With reference to FIG. 8, in count processing of set pickup time, CPU 101 detects a time measured in step S130, step SA60, or step SA180, and advances the process to step SX20.

Here, information managed in each job in MFP 100A will be explained. In MFP 100A, such information is managed by a printing job output management table. One example of such information is shown in Table 3.

TABLE 3
Printing job output management table of MFP-A Current time: 17:00

| | | | | | | Neglected | |
|---|---|---|---|---|---|---|---|
| | | | First mail | Second mail | Third mail | time (pickup | |
| User | | Job completion | notification | notification | notification | time after | Job pickup |
| name | Job name | time | time | time | time | print output) | time |
| User A | AA1 | 9:00 | — | — | — | 0:10 | Pickup at |
| | | | | | | | 9:10 |
| User A | AA2 | 10:00 | 10:30 | — | — | 0:40 | Pickup at |
| | | | | | | | 10:40 |
| User A | AA3 | 11:00 | 11:30 | — | — | 0:30 | Pickup at |
| | | | | | | | 11:30 |
| User A | AA4 | 12:00 | 12:30 | 13:00 | — | 1:30 | Pickup at |
| | | | | | | | 13:30 |
| User B | BB1 | 13:20 | 14:00 | — | — | 0:45 | Pickup at |
| | | | | | | | 14:10 |
| User C | CC1 | 13:25 | — | — | — | 0:05 | Pickup at |
| | | | | | | | 13:30 |
| User A | AA5 | 13:30 | 14:00 | 14:30 | 16:30 | 3:30 | Pickup at |
| | | | | | | | 17:00 |
| User A | AA6 | 13:35 | 14:05 | 14:35 | 16:35 | 3:25 | Pickup at |
| | | | | | | | 17:00 |
| User A | AA7 | 13:40 | 14:10 | 14:40 | 16:40 | 3:20 | Pickup at |
| | | | | | | | 17:00 |
| User A | AA8 | 13:45 | 14:15 | 14:45 | 16:45 | 3:15 | Pickup at |
| | | | | | | | 17:00 |
| . | . | . | . | | . | . | |

Table 3 stores for each job, user name who has transmitted a printing request of the job to MFP 100A, name of the job (job name), time at which the job has completed (job completion time), times at which mails are sent based on notification setting times (1) to (3) for the job (first to third mail notification times), time from completion of the job to the point of time when exit sensor 155 detects that sheet is removed from exit tray 19 (neglected time), and time at which exit sensor 155 detects that sheet of the job is removed from exit tray 19 (job pickup time).

Further, Table 4 and Table 5 respectively show printing job output management tables in different situations in MFP 100A.

TABLE 4
Printing job output management table of MFP-A Current time: 21:00

| | | | | | | Neglected | |
|---|---|---|---|---|---|---|---|
| | | | | | | time | |
| | | | | Second | | (pickup | |
| | | Job | First mail | mail | Third mail | time after | |
| User | | completion | notification | notification | notification | print | |
| name | Job name | time | time | time | time | output) | Job pickup time |
| User A | AA1 | 9.00 | — | — | — | 0:10 | Pickup at 9:10 |
| User A | AA2 | 10:00 | 10:30 | — | — | 0:40 | Pickup at 10:40 |
| User A | AA3 | 11:00 | 11:30 | — | — | 0:30 | Pickup at 11:30 |
| User A | AA4 | 12:00 | 12:30 | 13:00 | — | 1:30 | Pickup at 13:30 |
| User B | BB1 | 13:20 | 14:00 | — | — | 0:45 | Pickup at 14:10 |
| User C | CC1 | 13:25 | — | — | — | 0:05 | Pickup at 13:30 |
| User A | AA5 | 13:30 | 14:00 | 14:30 | 16:30 | 3:30 | Pickup at 17:00 |
| User A | AA6 | 13:35 | 14:05 | 14:35 | 16:35 | 3:25 | Pickup at 17:00 |
| User A | AA7 | 13:40 | 14:10 | 14:40 | 16:40 | 3:20 | Pickup at 17:00 |
| User A | AA8 | 13:45 | 14:15 | 14:45 | 16:45 | 3:15 | Pickup at 17:00 |
| User A | AA9 | 17:30 | 17:30 | 18:30 | 20:30 | — | Not printed |
| User A | AA10 | 17:35 | 17:35 | 18:35 | 20:35 | — | Not printed |
| | | | | | | | Output jobs AA9, |
| | | | | | | | AA10 picked up by |
| | | | | | | | turning ON print |
| | | | | | | | key at 20:40 |

TABLE 5
Printing job output management table of MFP-A Current time: 13:00
User A: relaxed from print output prohibited state

| | | | | | | Neglected | |
|---|---|---|---|---|---|---|---|
| | | | | | | time | |
| | | | | Second | | (pickup | |
| | | Job | First mail | mail | Third mail | time after | |
| User | Job | completion | notification | notification | notification | print | |
| name | name | time | time | time | time | output) | Job pickup time |
| User A | AA11 | 9:00 | — | — | — | 0:05 | Pickup at 9:05 (by |
| | | | | | | | turning ON print key) |
| User A | AA12 | 10:00 | — | — | — | 0:05 | Pickup at 10:05 (by |
| | | | | | | | turning ON print key) |
| User A | AA13 | 10:05 | — | — | — | 0:05 | Pickup at 10:10 (by |
| | | | | | | | turning ON print key) |
| User A | AA14 | 10:10 | — | — | — | 0:05 | Pickup at 10:15 (by |
| | | | | | | | turning ON print key) |
| User A | AA15 | 10:15 | — | — | — | 0:05 | Pickup at 10:20 (by |
| | | | | | | | turning ON print key) |
| User A | AA16 | 10:50 | — | — | — | 0:05 | Pickup at 10:55 (print |
| | | | | | | | after approach to MFP- |
| | | | | | | | A) |
| User A | AA17 | 10:55 | — | — | — | 0:05 | Pickup at 11:00 (print |
| | | | | | | | after approach to MFP- |
| | | | | | | | A) |
| User A | AA18 | 11:00 | — | — | — | 0:05 | Pickup at 11:05 (print |
| | | | | | | | after approach to MFP- |
| | | | | | | | A) |
| User A | AA19 | 11:10 | — | — | — | 0:05 | Pickup at 11:15 (print |
| | | | | | | | after approach to MFP- |
| | | | | | | | A) |
| User A | AA20 | 11:20 | — | — | — | 0:35 | Pickup at 11:55 (print |
| | | | | | | | after approach to MFP- |
| | | | | | | | A) |
| User A | AA21 | 11:30 | — | — | — | — | Pickup at 11:35 |
| User A | AA22 | 11:40 | — | — | — | — | Pickup at 11:50 |

Printing job output management tables shown in Tables 3 to 5 is stored, for example, in RAM 106. CPU 101 makes RAM 106 store time measured in step S130, step SA60, or step SA180 as “neglected time” of each table.

Returning to FIG. 8, in step SX20, CPU 101 decides whether or not the set pickup time detected in step SX10 is within a range of predetermined set time α(“αmin.” as will be described later), and when it is decided as Yes, the process advances to step SX40, and when it is decided as No, the process advances to step SX30.

In step SX30, a count of a counter concerning number of succession in operation limitation relaxing information management table (hereinafter, referred to as “succession counter”) is cleared to return the process.

Now, explanation will be given about operation limitation relaxing information management table. In MFP 100A, information for relaxing operation limitation setting information for each user (for example, changing III to II, or changing II to I), is stored in the form of an operation limitation relaxing information management table in HDD 108 or the like. Table 6 shows one example.

TABLE 6
Operation limitation relaxing information management table

| | | Succession | Operation limitation |
|---|---|---|---|
| User name | Relaxing condition | number | relaxing settings |
| User A | Pickup in 10 min. after | 5 | III→II→I |
| | printing instruction | | |
| User B | Pickup in 5 min. after | 4 | |
| | printing instruction | | |
| User C | Pickup in 15 min. after | 3 | |
| | printing instruction | | |
| . | . | . | |

With reference to Table 6, an operation limitation relaxing information management table stores for each user, relaxing condition, and number of times (number of succession) for which the relaxing condition should be achieved for the above “relaxation”. The relaxing condition differs by user because the setting is changed in consideration of difference depending on positional condition of user, for example, difference in positional condition between user situated (seated) at relatively long distance from MFP, and user situated at relatively short distance from MFP. Of course, such relaxing condition may be set equally for every user.

In the following description, time set in “relaxing condition” in operation limitation relaxing information management table shown in Table 6 for each user is referred to as “α min.” and number of times set in “number of succession” is referred to as “β times”.

Referring again to FIG. 8, in step SX40, CPU 101 counts up a count of the aforementioned succession counter by 1 and advances the process to step SX50.

In step S50, CPU 101 decides whether or not the count of the succession counter is β or more, in other words, whether or not the user who is an object of processing executes picking up outputted sheet in α min from output of the printing job transmitted by the user successively β times. When it is decided as Yes, CPU 101 advances the process to step SX60, and when it is decided as No, the process is returned.

In step SX60, CPU 101 decides whether or not the user who is an object of processing is a user for which operation limitation setting information is set, and when it is decided as Yes, the process advances to step SX70, and when it is decided as No, the process is returned.

In step SX70, CPU 101 relaxes operation limitation setting information for a user who is an object of processing (in FIG. 8, referred to as “user A”) by one stage, and the process is returned. Relaxing operation limitation setting information by one stage means returning to previous level, specifically, changing III to II, or changing II to I.

Here, information on jobs from the job named “AA16” to the job which is information on job concerning user A in Table 5 will be considered. For these jobs, user A successively picks up outputted sheets four times with a neglected time of 5 minutes. In other words, the user successively satisfies the relaxing condition about user A described in the operation limitation relaxing information management table of Table 6 four times. However, in Table 5, neglected time of the job “AA20” which follows “AA19” is 35 minutes, and hence the relaxing condition about user A described in the operation limitation relaxing information management table of Table 6 is not satisfied. In other words, since the above relaxing condition is not satisfied in “AA 20”, the relaxing condition is no longer satisfied over number of times of succession descried in Table 6. As a result, for the jobs of “AA16”-“AA20”, operation limitation setting information on user A will not be relaxed. If the neglected time of job AA20 in Table 5 is within 10 minutes, the relaxing condition is satisfied successively five times, namely the times defined as a number of times of succession in Table 6 for jobs “AA16” to “AA20”, so that the operation limitation setting information on user A is relaxed by one stage.

With reference to Table 4, a concrete operation in MFP 100A when operation limitation setting information on user A is III will be explained.

In any of jobs of job names “AA5” to “AA8”, neglected time is set to 3 hours or more. In other words, user A neglects the sheet outputted as printing job four times successively and for 3 hours or more. In the present example, operation limitation setting information on user A is II. Referring to the setting time management table of Table 2, when the operation limitation setting information on user A is II, notification by mail is made every hour after print output in particular, as seen from the column of the accumulative number, and after four notifications, printing operation is permitted only when MFP 100A is directly operated after transmission of printing job, in particular, as seen from the column of operation limitation content. In correspondence with this, in Table 4, after jobs AA5 to AA8, jobs of job AA9 and subsequent jobs (namely, job AA9 and job AA10) are outputted in condition that a print key on operational unit 162 is operated.

In the above, printing operation in MFP 100A has been explained. MFP 100A is also able to perform a process based on operation limitation setting information for each user in the case of copying operation.

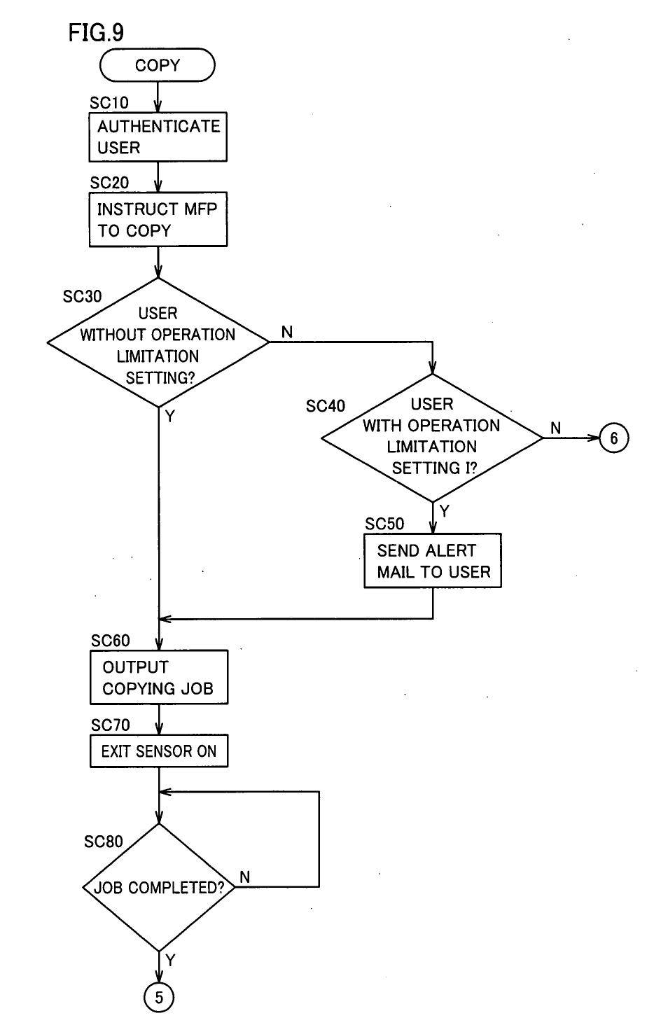

Next, referring to FIG. 9 to FIG. 12 which are flowcharts of process of copying operation, a process will be explained in execution of process for causing scanner unit 13 of MFP 100A to read a document and causing printer unit 14 of MFP 100A to output an image of the document, namely in execution of copying.

First, with reference to FIG. 9, when an operation for requesting copying is made on operational unit 162, CPU 101 conducts user authentication on the user who made the operation in step SC10, and advances the process to step SC20.

In step SC20, CPU 101 instructs scanner unit 13 and printer unit 14 to execute copying job, and advances the process to step SC30. In this context, the term “copying job” means that scanner unit 13 is caused to read a document, and printer unit 14 is caused to output the document read by scanner unit 13 according to copying condition inputted through operational unit 162.

In step SC30, CPU 101 decides whether or not the user authenticated in step SC10 is the user for which operation limitation setting information is not stored, by looking up the user information management table, and when it is decided as Yes, the process advances to step SC60, and when it is decided as No, the process advances to step SC40.

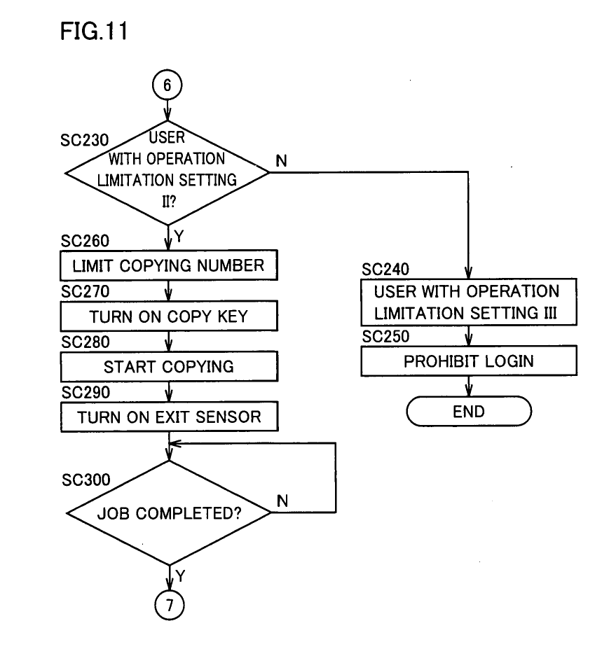

In step SC40, CPU 101 decides whether or not the user authenticated in step SC10 is a user whose operation limitation setting information is set to I, and when it is decided as Yes, the process advances to step SC50, and when it is decided as No, the process advances to step SC230 (see FIG. 11).

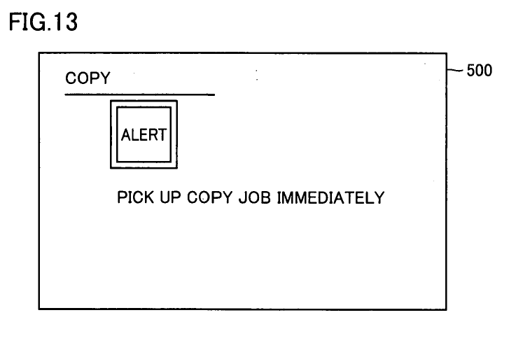

In step SC50, CPU 101 sends an alert mail to the user authenticated in step SC10, and advances the process to step SC60. CPU 101 acquires a mail address of the user by looking up the user information management table. The alert mail sent in this case may be a message of “Please pick up copying job immediately”. In step SC50, an image 500 as shown in FIG. 13 may be displayed in display unit 161.

In step SC60, CPU 101 causes printer unit 14 to output the copying job instructed in step SC20, and advances the process to step SC70.

In step SC70, CPU 101 turns ON output of exit sensor 155 (starts checking of detected output of exit sensor 155); and advances the process to step SC80.

In step SC80, CPU 101 decides whether or not the copying job instructed in step SC20 has completed, and when it is decides as Yes, the process advances to step SC90.

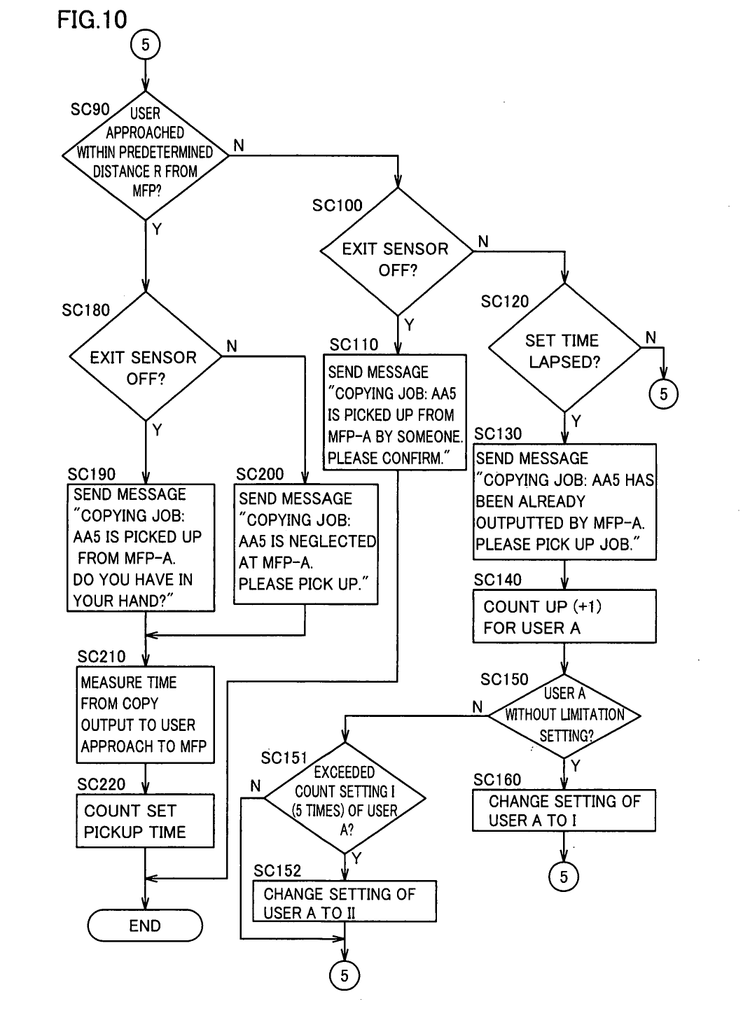

With reference to FIG. 10, in step SC90, CPU 101 decides whether or not the user has approached within distance R from MFP 100, and when it is decided as Yes, the process advances to step SC180, and when it is decided as No, the process advances to step SC100.

In step SC180, whether or not detection output of exit sensor 155 is OFF is judged, and when the judgment result shows OFF, the process advances to step SC190, and when the judgment result does not show OFF, the process advances to step SC200.

In step SC190, CPU 101 sends a message notifying that a sheet outputted according to the copying job is picked up, to mobile terminal 400 of the user who has transmitted the copying job outputted in step SC60, and advances the process to step SC210. For example, when the copying job outputted in step SC60 is named “AA5”, and MFP 100A is named “MFP-A” in the image processing system, in step SC190, for example, a message “Copying job: AA5 is picked up from MFP-A. Do you have in your hand?” is sent.

In step SC200, CPU 101 sends a message notifying that a sheet of copying job outputted in step SC60 is neglected, to the user authenticated in step SC10. In the image processing system, when copying job and MFP 100A are named as described above, in step SC200, for example, a message “Copying job: AA5 is neglected at MFP-A. Please pick up”, is sent.

In step SC210, CPU 101 measures a time from output of copying job in step SC60 to the point of time when the user approaches MFP 100A (it is decided in step SC90 that the user has approached within distance R from MFP 100A), and advances the process to step SC220.

In step SC220, CPU 101 executes count processing of set pickup time, and ends the process. Count processing of set pickup time is a process described with reference to FIG. 8.

On the other hand, in step SC100, CPU 101 judges whether or not output of exit sensor 155 is OFF, and when the judgment result shows OFF, the process advances to step SC110, and when the judgment result does not show OFF, the process advances to step SC120.

In step SC110, CPU 101 sends a message notifying that a sheet of copying job transmitted by the user is picked up by someone, to mobile terminal 400 of the user authenticated in step SC10, and ends the process. When the transmitted copying job is named “AA5”, and MFP 100A is named “MFP-A” in the image processing system, for example, a message “Copying job: AA5 is picked up by someone from MFP-A. Please confirm.” is sent in step SC110.

In step SC120, CPU 101 decides whether or not a time set for each user has lapsed from outputting copying job in step SC60. A set time for each user looked up here is shown in Table 7.

TABLE 7
User operation limitation settings (at copying)

| User name | Notification setting time | Operation limitation setting | |
|---|---|---|---|
| User A | (1) Notify via mail after 5 min. | I | Display alert at second time |
| | (2) Notify via mail after 30 min. | II | Limit copying number to 50 at fifth time |
| | (3) Notify via mail after 1 hr. | III | Prohibit user login at second time |
| User B | (1) Notify via mail after 5 min. | I | Display alert at third time |
| | (2) Notify via mail after 30 min. | II | Limit copying number to 50 at fourth time |
| | (3) Notify via mail after 1 hr. | III | Prohibit user login at third time |
| User C | (1) Notify via mail after 5 min. | I | Display alert at second time |
| | (2) Notify via mail after 30 min. | II | Limit copying number to 50 at fifth time |
| | (3) Notify via mail after 1 hr. | III | Prohibit user login at second time |
| . | . | | . |

Operation limitation setting I: alert mail
Operation limitation setting II: limit copying number
Operation limitation setting III: Prohibit login

Table 7 is one example of setting time management table concerning copying job stored in HDD 108, for example. In this setting time management table, notification setting times (1) to (3) for each user, the accumulative numbers for respective notification setting times, and operation limitation contents corresponding to operation limitation setting information on each user are stored.

Notification setting time means a time after execution of copying job transmitted to MFP 100 from each user, to the point of time when the user is notified by mail.

The accumulative number is number of times of notification by mail of each of (1) to (3) conducted for each user.

Operation limitation content is content concerning limitation of operation or the like imposed on each user in execution of copying job to MFP 100A.

Referring again to FIG. 10, when it is decided that a set time has lapsed in step SC120, CPU 101 sends in step SC130 a massage for requesting job pickup to the user who has transmitted the job outputted in step SC60. When the names of copying job and MFP 100A are “AA5” and “MFP-A”, respectively, as described above, a message “Copying job: AA5 has been already outputted in MFP-A. Please pick up the job.” is sent in step SC130 to a mobile phone set of the user. When operation limitation setting information is not set for the user who has transmitted the copying job outputted in step SC60, in step SC120, CPU 101 decides whether or not a predetermined time (for example, 1 hour) has lapsed.

In step SC140, CPU 101 counts up the accumulative number in the setting time management table by one, and advances the process to step SC150. The accumulative number counted up here is an accumulative number corresponding to the time which is decided to have lapsed in previous step SC120 in notification setting times (1) to (3) for the user having transmitted the copying job outputted in step SC60.

In step SC150, CPU 101 decides whether or not the user having transmitted the copying job outputted in step SC60 is a user for which operation limitation setting information is not set, and when it is decided as Yes, the process advances to step SC160, and when it is decided as No, the process advances to step SC151.

In step SC160, limitation setting of the user is changed to “setting I” and the process is returned to step SC90.

On the other hand, in step SC151, CPU 101 decides whether or not the accumulative number corresponding to I of user for which the accumulative number is counted up in step SC140 exceeds the number defined by operation limitation content, and when it is decided as Yes, the process advances to step SC152, and when it is decided as No, the process is returned to step SC90.

In step SC152, CPU 101 updates operation limitation setting information on the user for which the accumulative number is counted up in step SC140 to II, and returns the process to step SC90.

In the foregoing process explained with reference to FIG. 10, for a user for which information is not registered in operation limitation setting information (user without operation limitation setting), when the user does not approach within distance R from MFP 100A for a predetermined time or more after the copying job transmitted by MFP 100A is outputted in step SC60, the fact that the job has been already outputted is notified to a mobile terminal of the user, and operation limitation setting information on the user is set to I.

In the foregoing process explained with reference to FIG. 9 and FIG. 10, when a user for which operation limitation setting information is set to I transmits copying job to MFP 100A, MFP 100A outputs the copying job after sending an alert mail to mobile terminal 400 of the user. The alert mail may be a screen display (see FIG. 13) in MFP 100A. Likewise the case where there is no operation limitation setting information, when the user does not approach within distance R from MFP 100A, the fact that the job has been already outputted is notified according to the time after output of the job, and when the accumulative number exceeds an upper limit defined by the operation limitation content, the operation limitation setting information is updated to II.

In the foregoing process described with reference to FIG. 9 and FIG. 10, when operation limitation setting information on the user having transmitted copying job to MFP 100A is I or not set, the transmitted copying job is executed even when the user does not approach MFP 100A. Accordingly, in MFP 100A of the present embodiment, when exit sensor 155 comes into OFF (not detecting sheet) after a sheet is outputted to exit tray 19 following execution of copying job and before the user having transmitted the copying job approaches within distance R from MFP 100A, a message is sent to the user.

On the other hand, when it is decided in step SC40 that operation limitation setting information on the user authenticated in step SC10 is not I, CPU 101 advances the process to step SC230 (see FIG. 11). In step SC230, CPU 101 decides whether or not the operation limitation setting information on the user authenticated in step SC10 is II, and when it is decided as Yes, the process advances to step SC260, and when it is decided as No, the process advances to step SC240.

In step SC260, CPU 101 gives limitation of copying number to the user authenticated in step SC10, and starts copying operation in step SC280 upon operation of a print key (part of operational unit 162) in step SC270.

CPU 101 turns ON output of exit sensor 155 in step SC290 likewise in step SC70, and advances the process to step SC300.

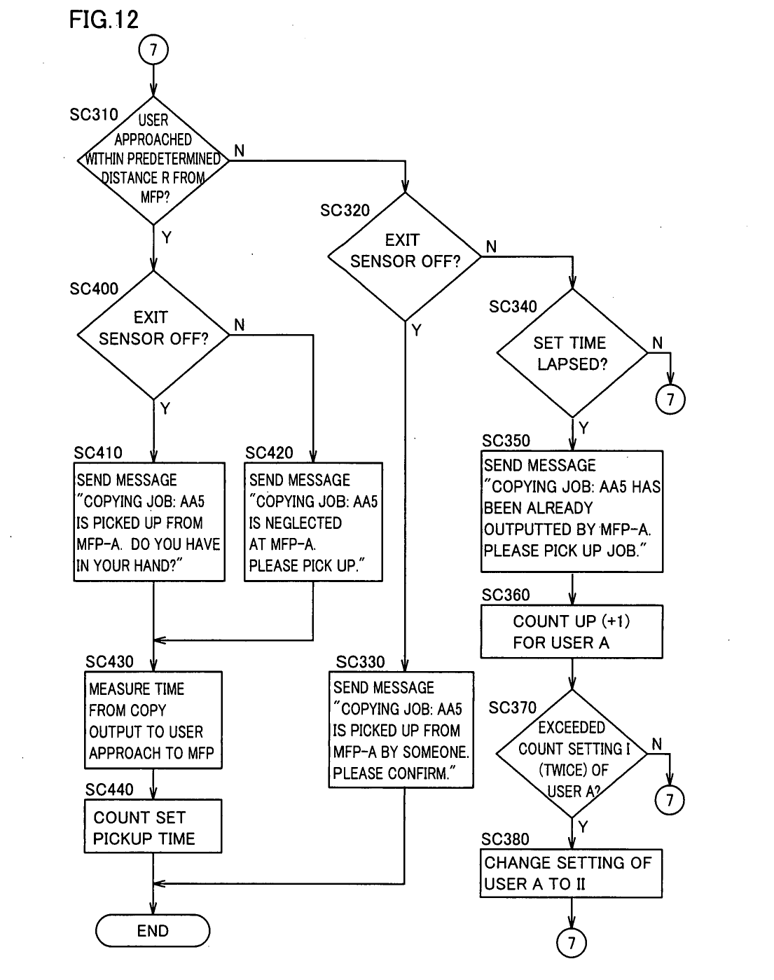

In step SC300, CPU 101 checks whether or not the copying job started in step SC280 has completed, and when it is decided as Yes, the process advances to step SC310 (see FIG. 12).

On the other hand, in step SC240, CPU 101 decides that operation limitation setting information on the user who is a current object of decision is III, and advances the process to step SC250. Then CPU 101 makes settings in step SC250 that prohibit acceptance of login of the user from then on, and ends the process. After processing of step SC250, CPU 101 will not execute processing subsequent to user authentication in step SC10 unless the content of settings is changed by a manager or the like.

With reference to FIG. 12, in step SC310, CPU 101 decides whether or not the user authenticated instep SC10 approaches within distance R from MFP 100, and when it is decided as Yes, the process advances to step SC400, and when it is decided as No, the process advances to step SC320.

In step SC400, whether or not detection output of exit sensor 155 is turned OFF is judged, and when the judgment result shows OFF, the process advances to step SC410, and when the judgment result does not show OFF, the process advances to step SC420.

In step SC410, CPU 101 sends a message notifying that a sheet outputted according to the copying job is picked up, to mobile terminal 400 of the user who has transmitted the copying job outputted in step SC60, and advances the process to step SC430. For example, when the copying job outputted in step SC60 is named “AA5”, and MFP 100A is named “MFP-A” in the image processing system, in step SC410, for example, a message “Copying job: AA5 is picked up from MFP-A. Do you have in your hand?” is sent.

In step SC420, CPU 101 sends a message notifying that a sheet of copying job outputted in step SC60 is neglected, to the user authenticated in step SC10. In the image processing system, when copying job and MFP 100A are named as described above, in step SC420, for example, a message “Copying job: AA5 is neglected at MFP-A. Please pick up”, is sent.

In step SC430, CPU 101 measures a time from output of copying job in step SC60 to the point of time when the user approaches MFP 100A (it is decided in step SC310 that the user has approached within distance R from MFP 100A), and advances the process to step SC440.

In step SC440, CPU 101 executes count processing of set pickup time, and ends the process. Count processing of set pickup time is a process described with reference to FIG. 8.

On the other hand, in step SC320, CPU 101 judges whether or not output of exit sensor 155 is OFF, and when the judgment result shows OFF, the process advances to step SC10, and when the judgment result does not show OFF, the process advances to step SC340.

In step SC330, CPU 101 sends a message notifying that a sheet of copying job transmitted by the user is picked up by someone, to mobile terminal 400 of the user authenticated in step SC10, and ends the process. When the transmitted copying job is named “AA5”, and MFP 100A is named “MFP-A” in the image processing system, for example, a message “Copying job: AA5 is picked up by someone from MFP-A. Please confirm.” is sent in step SC330.

In step SC340, CPU 101 decides whether or not a time set for each user has lapsed from outputting copying job in step SC60. Since set time for each user looked up here is shown in Table 7, repeated explanation is omitted here.

When it is decided that a set time has lapsed in step SC340, CPU 101 sends in step SC350 a massage for requesting job pickup to the user who has transmitted the job outputted in step SC60. When the names of copying job and MFP 100A are “AA5” and “MFP-A”, respectively, as described above, a message “Copying job: AA5 has been already outputted in MFP-A. Please pick up the job.” is sent in step SC350 to a mobile phone set of the user.

In step SC360, CPU 101 counts up the accumulative number in the setting time management table by one, and advances the process to step SC370. The accumulative number counted up here is an accumulative number corresponding to the time which is decided to have lapsed in previous step SC340 in notification setting times (1) to (3) for the user having transmitted the copying job outputted in step SC60.

In step SC360, CPU 101 decides whether or not the accumulative number corresponding to II of user for which the accumulative number is counted up in step SC360 exceeds the number defined by operation limitation content, and when it is decided as Yes, the process advances to step SC380, and when it is decided as No, the process is returned to step SC310.

In step SC380, limitation setting of the user is changed to “setting III”, and the process is returned to step SC310.

In the foregoing process as explained with reference to FIG. 9 to FIG. 12, when a user whose operation limitation setting information is II transmits copying job to MFP 100A, the copying job is executed in condition that the copy key is operated again. When the user does not approach within distance R from MFP 100A after transmitting copying job, the accumulative number in setting time management table is counted up according to lapse time from transmission of the copying job. When the accumulative number exceeds an upper limit number defined by operation limitation setting information on the user, operation limitation setting information on the user is set to III.

In the foregoing process explained with reference to FIG. 11, when a user whose operation limitation setting information is III instructs copying job to MFP 100A, login of the user is prohibited, and the instructed copying job is not executed.

In the above, copying operation in MFP 100A has been explained. MFP 100A is also able to perform a process based on operation limitation setting information for each user in the case of scanning operation.

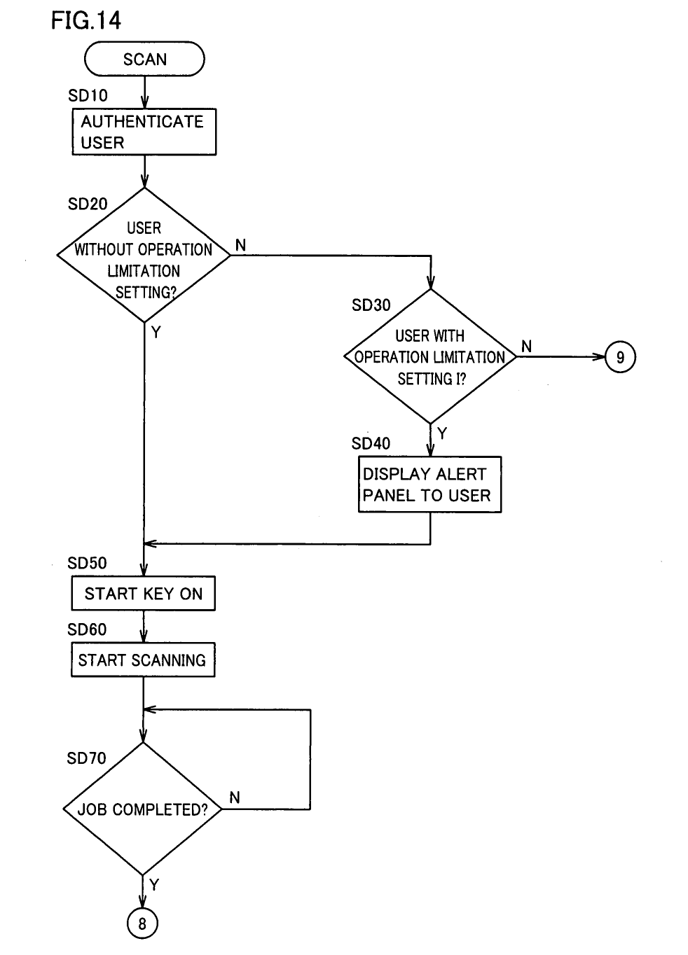

Next, referring to FIG. 14 to FIG. 17 which are flowcharts of process of scanning operation, a process will be explained in execution of process for causing scanner unit 13 of the MFP 100A to read a document and creating a file of the read image for storing in HDD 108 of MFP 100A or for sending via mail or the like, namely in execution of scanning operation.

First, with reference to FIG. 14, when an operation for requesting scanning operation is made on operational unit 162, CPU 101 conducts user authentication on the user who made the operation in step SD10, and advances the process to step SD20.

In step SD20, CPU 101 decides whether or not the user authenticated in step SD10 is the user for which operation limitation setting information is not stored by looking up the user information management table, and when it is decided as Yes, the process advances to step SD50, and when it is decided as No, the process advances to step SD30.

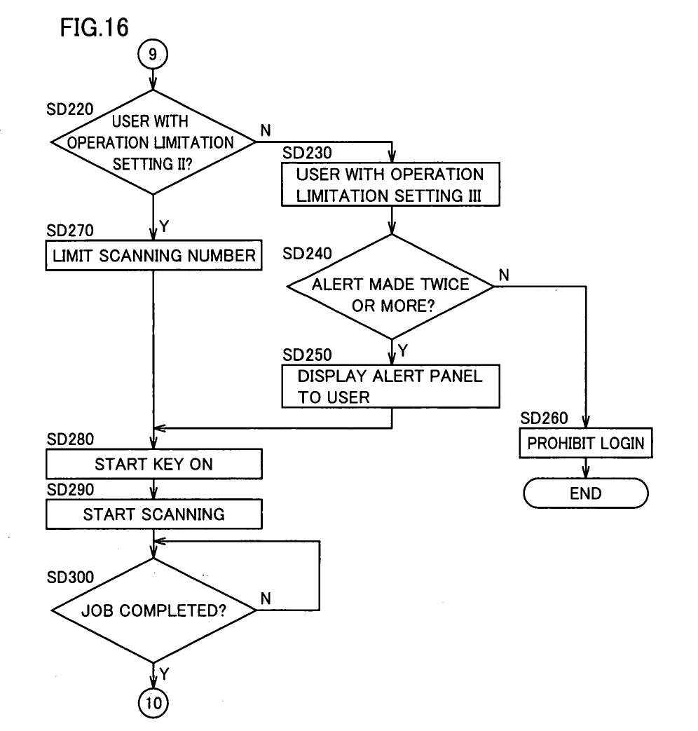

In step SD30, CPU 101 decides whether or not the user authenticated in step SD10 is a user whose operation limitation setting information is set to I, and when it is decided as Yes, the process advances to step SD40, and when it is decided as No, the progress advances to step SD220 (see FIG. 16).

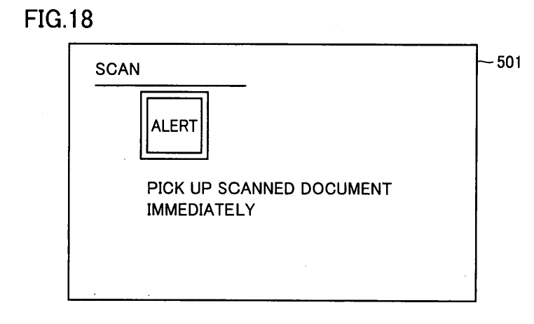

In step SD40, CPU 101 sends an alert mail to the user authenticated in step SD10, and advances the process to step SD50. CPU 101 acquires a mail address of the user by looking up the user information management table. The alert mail sent in this case may be a message of “Please pick up scanned document immediately”. In step SD40, an image 501 as shown in FIG. 18 may be displayed in display unit 161.

In step SD50, CPU 101 advances the process to step SD60 after waiting for turning ON (operation) of start key on operational unit 162. In step SD60, CPU 101 starts scanning a document set in scanner unit 13, and advances the process to step SD70.

In step SD70, CPU 101 decides whether or not the scanning job started in step SD60 has completed, and when it is decides as Yes, the process advances to step SD80.

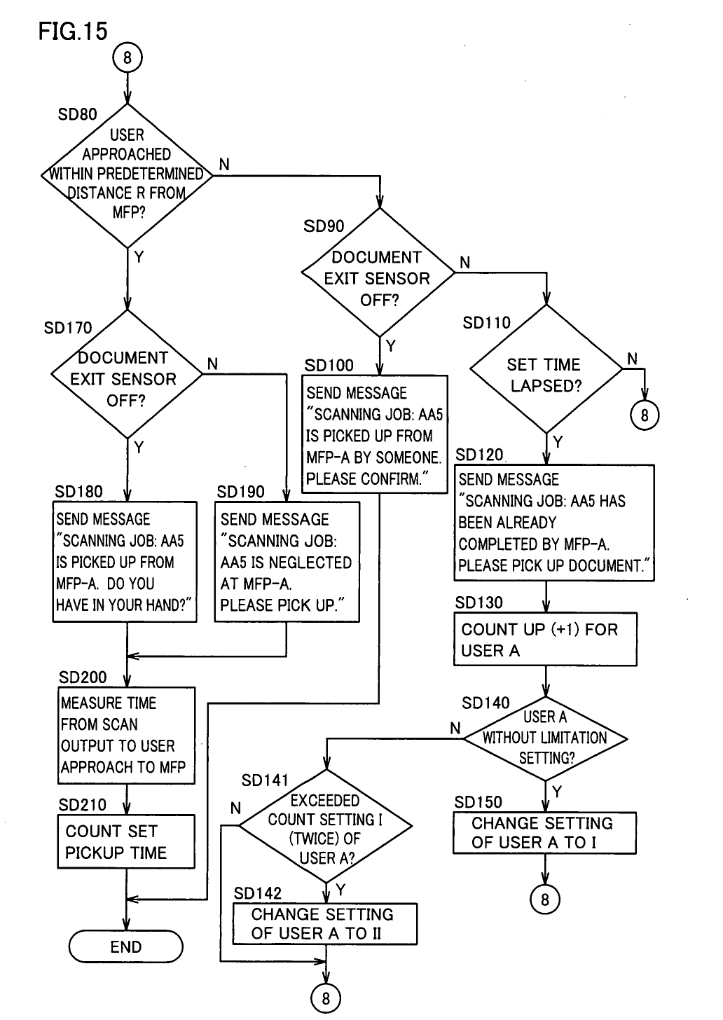

With reference to FIG. 15, in step SD80, CPU 101 decides whether or not the user has approached within distance R from MFP 100, and when it is decided as Yes, the process advances to step SD170, and when it is decided as No, the process advances to step SD90.

In step SD170, whether or not detection output of exit sensor 155A is OFF, or whether or not a document of scanning job started in step SD60 is removed is judged, and when the judgment result shows OFF, the process advances to step SD180, and when the judgment result does not show OFF, the process advances to step SD190.

In step SD180, CPU 101 sends a message notifying that a document of the scanning job is picked up, to mobile terminal 400 of the user who has instructed the scanning job started in step SD60 (user who has logged in step SD10), and advances the process to step SD200. For example, when the scanning job instructed in step SD60 is named “AA5”, and MFP 100A is named “MFP-A” in the image processing system, in step SD180, for example, a message “Scanning job: AA5 is picked up from MFP-A. Do you have in your hand?” is sent.

In step SD190, CPU 101 sends a message notifying that a document of scanning job outputted in step SD60 is neglected, to the user authenticated in step SD10. In the image processing system, when scanning job and MFP 100A are named as described above, in step SD190, for example, a message “Document of scanning job: AA5 is neglected at MFP-A. Please pick up”, is sent.

In step SD200, CPU 101 measures a time from confirmation of completion of scanning job in step SD70 to the point of time when the user approaches MFP 100A (it is decided in step SD80 that the user has approached within distance R from MFP 100A), and advances the process to step SD210.

In step SD210, CPU 101 executes count processing of set pickup time and ends the process. Count processing of set pickup time is a process described with reference to FIG. 8.

On the other hand, in step SD90, CPU 101 judges whether or not output of exit sensor 155 is OFF, and when the judgment result shows OFF, the process advances to step SD100, and when the judgment result does not show OFF, the process advances to step SD110.

In step SD100, CPU 101 sends a message notifying that a document of scanning job transmitted by the user is picked up by someone, to mobile terminal 400 of the user authenticated in step SD10, and ends the process. When the transmitted scanning job is named “AA5”, and MFP 100A is named “MFP-A” in the image processing system, for example, a message “Scanning job: AA5 is picked up by someone from MFP-A. Please confirm.” is sent in step SD100.

In step SD110, CPU 101 decides whether or not a time set for each user has lapsed from confirming completion of scanning job in step SD70. A set time for each user looked up here is shown in Table 8.

TABLE 8
User operation limitation setting (at scanning)

| User name | Notification setting time | Operation limitation setting | |
|---|---|---|---|
| User A | (1) Notify via mail after 5 min. | I | Display alert at second time |
| | (2) Notify via mail after 30 min. | II | Limit scanning number to 50 at fifth time |
| | (3) Notify via mail after 1 hr. | III | Prohibit user login at second time |
| User B | (1) Notify via mail after 5 min. | I | Display alert at third time |
| | (2) Notify via mail after 30 min. | II | Limit scanning number to 50 at fourth time |
| | (3) Notify via mail after 1 hr. | III | Prohibit user login at third time |
| User C | (1) Notify via mail after 5 min. | I | Display alert at second time |
| | (2) Notify via mail after 30 min. | II | Limit scanning number to 50 at fifth time |
| | (3) Notify via mail after 1 hr. | III | Prohibit user login at second time |
| . | . | | . |

Operation limitation setting I: alert mail
Operation limitation setting II: limit scanning number
Operation limitation setting III: Prohibit login

Table 8 is one example of setting time management table concerning scanning job stored in HDD 108, for example. In this setting time management table, notification setting times (1) to (3) for each user, the accumulative numbers for respective notification set times, and operation limitation contents corresponding to operation limitation setting information on each user are stored.

Notification setting time means a time after execution of scanning job transmitted to MFP 100 from each user, to the point of time when the user is notified by mail.

The accumulative number is number of times of notification by mail of each of (1) to (3) executed for each user.

Operation limitation content is content concerning limitation of operation or the like imposed on each user in execution of scanning job to MFP 100A.

Referring again to FIG. 15, when it is decided that a set time has lapsed in step SD110, CPU 101 sends in step SD120 a massage for requesting pickup of a document of job, to the user who has instructed the job for which completion is confirmed in step SD70 (user authenticated in step SD10). When the names of scanning job and MFP 100A are “AA5” and “MFP-A”, respectively, as described above, a message “Scanning job: AA5 is completed in MFP-A. Please pick up the document.” is sent in step SD120 to a mobile phone set of the user. When operation limitation setting information is not set for the user who has instructed the scanning job for which completion is confirmed in step SD70, CPU 101 decides whether or not a predetermined time (for example, 1 hour) has lapsed in step SD110.

In step SD130, CPU 101 counts up the accumulative number in the setting time management table by one, and advances the process to step SD140. The accumulative number counted up here is an accumulative number corresponding to the time which is decided to have lapsed in previous step SD110 in notification setting times (1) to (3) for the user who has instructed the scanning job of which completion is confirmed in step SD70.

In step SD140, CPU 101 decides whether or not the user who has instructed the scanning job of which completion is confirmed in step SD70 is a user for which operation limitation setting information is not set, and when it is decided as Yes, the process advances to step SD150, and when it is decided as No, the process advances to step SD141.

In step SD150, limitation setting of the user is changed to “setting I” and the process is returned to step SD80.

On the other hand, in step SD141, CPU 101 decides whether or not the accumulative number corresponding to I of user for which the accumulative number is counted up in step SD130 exceeds the number defined by operation limitation content, and when it is decided as Yes, the process advances to step SD142, and when it is decided as No, the process is returned to step SD80.

In step SD142, CPU 101 updates operation limitation setting information on the user for which the accumulative number is counted up in step SD130 to II, and returns the process to step SD80.

In the foregoing process explained with reference to FIG. 15, for a user for which information is not registered in operation limitation setting information, when the user does not approach within distance R from MFP 100A for a predetermined time or more after completion of scanning job transmitted to MFP 100A by the user is confirmed in step SD70, the fact that the job has been already completed is notified to a mobile terminal of the user, and operation limitation setting information on the user is set to I.

In the foregoing process explained with reference to FIG. 14 and FIG. 15, when a user for which operation limitation setting information is set to I transmits scanning job to MFP 100A, MFP 100A outputs the scanning job after sending an alert message to mobile terminal 400 of the user. The alert mail may be a screen display (see FIG. 18) in MFP 100A. Likewise the case where there is no operation limitation setting information, when the user does not approach to MFP 100A within a distance R, completion of scanning job is notified according to the time after completion of the scanning job, and when the accumulative number exceeds an upper limit defined by the operation limitation content, the operation limitation setting information is updated to II.

In the foregoing process described with reference to FIG. 14 and FIG. 15, when operation limitation setting information on the user having instructed scanning job to MFP 100A is I or not set, the instructed scanning job is executed even if a starting key is not particularly operated after instruction of scanning. Accordingly, in MFP 100A of the present embodiment, when exit sensor 155 comes into OFF (not detecting document) after a document is outputted to feeder unit 17 following execution of scanning job and before the user having instructed the scanning job approaches within distance R from MFP 100A, a message is sent to the user.

On the other hand, when it is decided in step SD30 that operation limitation setting information on the user authenticated in step SD10 is not I, CPU 101 advances the process to step SD220 (see FIG. 16). In step SD220, CPU 101 decides whether or not the operation limitation setting information on the user authenticated in step SD10 is II, and when it is decided as Yes, the process advances to step SD270, and when it is decided as No, the process advances to step SD230.

In step SD270, CPU 101 gives limitation of copying number to the user authenticated in step SD10, and starts copying operation in step SD290 upon operation of a start key (part of operational unit 162) in step SD280.

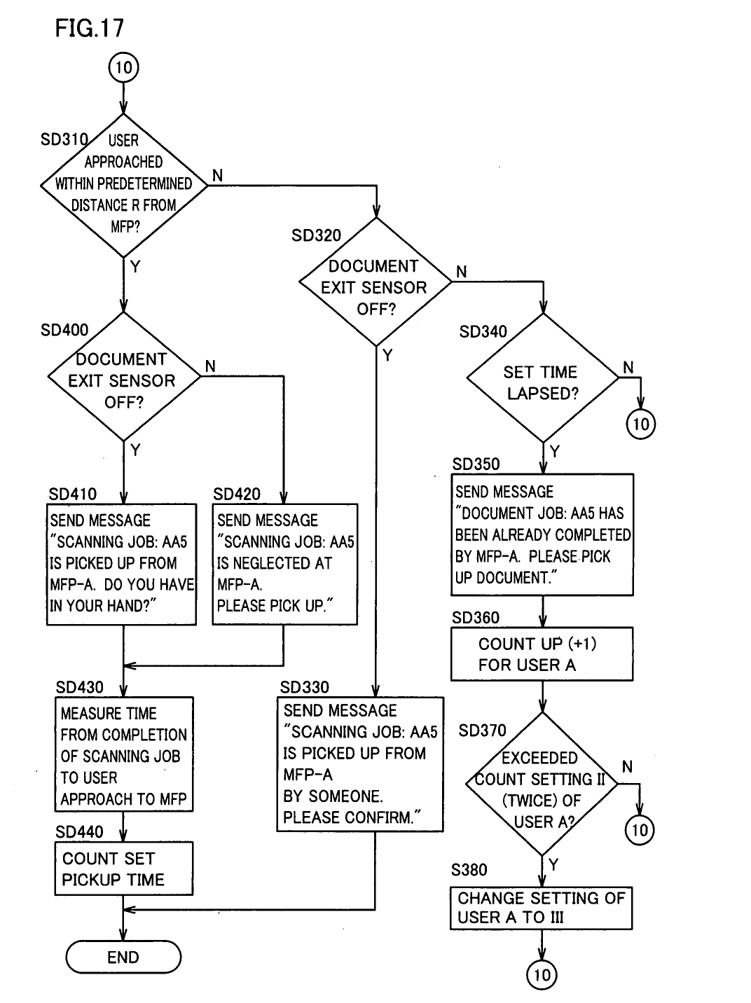

In step SD300, CPU 101 checks whether or not the scanning job started in step SD290 has completed, and when it is decided as Yes, the process advances to step SD310 (see FIG. 17).

On the other hand, CPU 101 decides that operation limitation setting information on the user which is a current object of decision is III in step SD230, and decides whether or not the alert by alert panel display in step SD250 as will be described later is transmitted twice or more times in step SD240, and when it is decided as Yes, the process advances to step SD260, and when it is decided as No, the process advances to step SD250.

In step SD260, CPU 101 makes settings that prohibits acceptance of login of the user from then on, and ends the process. After processing of step SD260, CPU 101 will not execute processing subsequent to user authentication in step SD10 unless the content of settings is changed by a manager or the like.

On the other hand, in step SD250, CPU 101 makes alert display on display unit 161 as shown in FIG. 18, and advances the process to step SD280. For processing of step SD240, CPU 101 preferably sets a flag simultaneously with execution of step SD250.

With reference to FIG. 17, in step SD310, CPU 101 decides whether or not the user authenticated in step SD10 has approached within distance R from MFP 100, and when it is decided as Yes, the process advances to step SD400, and when it is decided as No, the process advances to step SD320.

In step SD400, whether or not detection output of document exit sensor 155A is OFF is judged, and when the judgment result shows OFF, the process advances to step SD410, and when the judgment result does not show OFF, the process advances to step SD420.

In step SD410, CPU 101 sends a message notifying that a document of scanning job is picked up, to mobile terminal 400 of the user who has instructed the scanning job for which completion is confirmed in step SD70, and advances the process to step SD430. For example, when the job is named “AA5”, and MFP 100A is named “MFP-A” in the image processing system, in step SD410, for example, a message “Scanning job: AA5 is picked up from MFP-A. Do you have in your hand?” is sent.

In step SD420, CPU 101 sends a message notifying that a document of the scanning job for which completion is confirmed in step SD70 is neglected, to the user authenticated in step SD10. In the image processing system, when scanning job and MFP 100A are named as described above, in step SD420, for example, a message “Document of scanning job: AA5 is neglected at MFP-A. Please pick up”, is sent.

In step SD430, CPU 101 measures a time from confirmation of completion of scanning job in step SD70 to the point of time when the user approaches MFP 100A (it is decided in step SD310 that the user has approached within distance R from MFP 100A), and advances the process to step SD440.

In step SD440, CPU 101 executes count processing of set pickup time, and ends the process. Count processing of set pickup time is a process described with reference to FIG. 8.

On the other hand, in step SD320, CPU 101 judges whether or not output of document exit sensor 155A is OFF, and when the judgment result shows OFF, the process advances to step SD330, and when the judgment result does not show OFF, the process advances to step SD340.

In step SD330, CPU 101 sends a message notifying that a document of scanning job transmitted by the user is picked up by someone, to mobile terminal 400 of the user authenticated in step SD10, and ends the process. When the transmitted scanning job is named “AA5”, and MFP 100A is named “MFP-A” in the image processing system, for example, a message “Document of scanning job: AA5 is picked up by someone from MFP-A. Please confirm.” is sent in step SD330.

In step SD340, CPU 101 decides whether or not a time set for each user has lapsed from confirmation of completion of scanning job in step SD70. Since set time for each user looked up here is shown in Table 8, repeated explanation is omitted here.

When it is decided that a set time has lapsed in step SD340, CPU 101 sends in step SD350 a massage for requesting pickup of document to the user who has instructed the job for which completion is confirmed in step SD70. When the names of scanning job and MFP 100A are “AA5” and “MFP-A”, respectively, as described above, a message “Copying job: AA5 is completed in MFP-A. Please pick up the document.” is sent in step SD350 to a mobile phone set of the user.

In step SD360, CPU 101 counts up the accumulative number in the setting time management table by one, and advances the process to step SD370. The accumulative number counted up here is an accumulative number corresponding to the time which is decided to have lapsed in previous step SD340 in notification setting times (1) to (3) for the user having instructed the scanning job for which completion is confirmed in step SD70.

In step SD370, CPU 101 decides whether or not the accumulative number corresponding to II of user for which the accumulative number is counted up in step SD360 exceeds the number defined by operation limitation content, and when it is decided as Yes, the process advances to step SD380, and when it is decided as No, the process is returned to step SD310.

In step SD380, limitation setting of the user is changed to “setting III”, and the process is returned to step SD310.

In the foregoing process as explained with reference to FIG. 14 to FIG. 17, when a user whose operation limitation setting information is II instructs scanning job to MFP 100A, the scanning job is executed in condition that the start key is operated again. When the user does not approach within distance R from MFP 100A after completion of the scanning job, the accumulative number in setting time management table is counted up according to lapse time from completion of the scanning job. When the accumulative number exceeds an upper limit number defined by operation limitation setting information on the user, operation limitation setting information on the user is set to III.

In the foregoing process explained with reference to FIG. 16, when a user whose operation limitation setting information is III instructs copying job to MFP 100A, login of the user is prohibited, and the instructed copying job is not executed.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. An image processing apparatus comprising:
an exit tray collecting a printed sheet;
a user information storing unit storing information identifying a user and information identifying a mobile terminal while correlating with each other;
a judging unit judging whether or not a sheet is present on said exit tray;
a deciding unit deciding whether or not a user having transmitted a first printing request is situated within a predetermined distance from said image processing apparatus after a sheet is outputted to said exit tray based on said first printing request;
a selecting unit selecting a message based on results of judgment by said judging unit and decision by said deciding unit; and
a sending unit to sending the message selected by said selecting unit to a mobile terminal unit that is correlated in said user information storing unit with information identifying said user having transmitted said first printing request.

2. The image processing apparatus according to claim 1, further comprising:
a message storing unit storing a message and a combination of judgment result of said judging unit and decision result of said deciding unit, to relate each other,
wherein said selecting unit selects a message from messages stored in said message storing unit based on a combination of judgment result of said judging unit and decision result of said deciding unit.

3. The image processing apparatus according to claim 2, wherein
said message storing unit stores a message for every information identifying a user, and
said selecting unit selects a message from messages stored in said message storing unit based on information specifying the user having transmitted said first printing request.

4. The image processing apparatus according to claim 1, further comprising:
a time counting unit counting a time elapsed from output of sheet based on said first printing request,
wherein said selecting unit selects said message every predetermined time counted by said time counting unit until said judging unit judges that a sheet outputted based on said first printing request is absent in said exit tray, and
said sending unit outputs the message selected by said selecting unit every predetermined time counted by said time counting unit.

5. The image processing apparatus according to claim 4, wherein
said user information storing unit stores said predetermined time in correlation with information specifying the user for each user, and
said selecting unit selects a message whenever said predetermined time correlated with information identifying a user having transmitted said first printing request in said user information storing unit is counted.

6. A method of controlling an image processing apparatus that outputs a sheet to an exit tray by executing printing based on a printing request received via a network, comprising the steps of:
storing information identifying a user and information identifying a mobile terminal while correlating with each other;
judging whether or not a sheet is present on said exit tray;
outputting a sheet to said exit tray based on a first printing request;
deciding whether or not a user having transmitted said first printing request is situated within a predetermined distance from said image processing apparatus;
selecting a message based on results of judgment of the judging step and decision result of the deciding step; and
sending said selected message to a mobile terminal unit correlated with information identifying the user having transmitted said first printing request.

7. The method of controlling an image processing apparatus according to claim 6, further comprising the step of:
storing a message and a combination of judgment result of said judging step and decision result of said deciding step, to relate each other,
wherein said selecting step selects a message from messages stored in said message storing step based on a combination of judgment result of said judging step and decision result of said deciding step.

8. The method of controlling an image processing apparatus according to claim 7, wherein
said message storing step stores a message for every information identifying a user, and
said selecting step selects a message from messages stored in said message storing step based on information specifying the user having transmitted said first printing request.

9. The method of controlling an image processing apparatus according to claim 6, further comprising the step of:
counting a time elapsed from output of sheet based on said first printing request, wherein
said selecting step selects said message every predetermined time counted by said time counting unit until said judging unit judges that a sheet outputted based on said first printing request is absent in said exit tray, and
said sending step outputs the message selected in said selecting step every predetermined time counted by said time counting step.

10. The method of controlling an image processing apparatus according to claim 9, wherein
said user information storing step stores said predetermined time in correlation with information identifying the user for each user, and
said selecting step selects a message whenever said predetermined time correlated with information identifying a user having transmitted said first printing request in said user information storing step is counted.
